(19) United States
(12) Patent Application Publication
(10) Pub. No.: US 2026/0361773 A1
(43) Pub. Date: Nov. 12, 2026

(54) SYSTEMS AND METHODS FOR AUTOMATING SECURITY CONFIGURATION COMPLIANCE ASSESSMENT

(71) Applicant: SAUDI ARABIAN OIL COMPANY, Dhahran (SA)

(72) Inventor: Hussain Hashim ALHADDAD, Dhahran (SA)

(73) Assignee: SAUDI ARABIAN OIL COMPANY, Dhahran (SA)

(21) Appl. No.: 19/202,886

(22) Filed: May 8, 2025

(51) Int. Cl. H04L 9/40; G06N 20/00

(52) U.S. Cl. CPC H04L 63/205; G06N 20/00

(57) ABSTRACT

Misconfiguration detection systems having a database that stores a known misconfiguration table and a machine learning engine coupled to the database. The machine learning engine includes a training engine and an inference engine. The training engine trains a machine learning model to detect potential security misconfigurations within a target IT environment by inputting a dataset of known security configurations and misconfigurations, comparing it to an output dataset, and adjusting the model's weights. The inference engine applies the trained model to the IT environment, classifying potential security misconfigurations in real-time as known misconfigurations, suspicious misconfigurations, or compliant configurations based on the model's weights. Known misconfigurations are logged in the known misconfiguration table and reported to an administrator for remediation.

### BACKGROUND

Conventional methods of performing security configuration compliance assessments allow organizations to evaluate the adherence of their systems and applications to established security policies and standards. These methods facilitate the identification of vulnerabilities, misconfigurations, and non-compliance issues within an IT environment. Despite the utility of conventional assessment methods, several challenges persist that can impact their effectiveness and reliability. One challenge is the manual effort required to review and validate configurations, which can be time-consuming and prone to human error. Additionally, maintaining consistent compliance assessments across diverse systems and applications can be complex, especially in large organizations with varied information technology (IT) environments. Another issue is the limited scalability of traditional assessment methods, which may not adequately support dynamic or cloud-based infrastructures. Furthermore, security concerns arise from the potential for incomplete or outdated assessment data, necessitating robust monitoring and reporting mechanisms.

Although conventional techniques for security configuration compliance assessments have been developed and refined over many years, they may still be inadequate to achieve optimal results. Accordingly, there is an impetus to improve security configuration compliance assessment techniques to overcome current technological challenges by implementing improvements including, for example: enhancing the reliability of compliance assessments, increasing the accuracy of compliance assessments, reducing inefficiencies associated with compliance assessments, increasing the scalability of compliance assessments, reducing errors associated with compliance assessments, decreasing the cost of compliance assessments, and the like.

Consequently, there exists a need for further improvements to security configuration compliance assessment technology to overcome the aforementioned technical challenges and other challenges not mentioned.

### BRIEF SUMMARY

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Aspects of the present disclosure provide a misconfiguration detection system. The system may include a database, the database storing a known misconfiguration table. The system may include a machine learning engine coupled to the database. The machine learning engine may include a training engine configured to train a machine learning model to detect one or more potential security misconfigurations within an IT environment. The training may include inputting an input dataset, the input dataset including a set of known security configurations for the IT environment and known security misconfigurations for the IT environment. The training may include comparing the input dataset to an output dataset, the output dataset generated by the machine learning model. The training may include based on the comparing, adjusting one or more weights of the machine learning model. The machine learning model may include an inference engine configured to apply the machine learning model to the IT environment after the training. The applying may include classifying, in real-time based on the one or more weights, the one or more potential security misconfigurations as one or more known misconfigurations, one or more suspicious misconfigurations, or one or more compliant configurations. The applying may include logging each of the one or more known misconfigurations at the known misconfiguration table. The applying may include reporting each of the one or more known misconfigurations to an administrator for remediation.

Aspects of the present disclosure provide a method detecting misconfigurations. The method may include training, via a training engine, a machine learning model to detect one or more potential security misconfigurations within an IT environment. The training may include inputting an input dataset, the input dataset including a set of known security configurations for the IT environment and known security misconfigurations for the IT environment. The training may include comparing the input dataset to an output dataset, the output dataset generated by the machine learning model. The training may include, based on the comparing, adjusting one or more weights of the machine learning model. The method may include applying, via an inference engine, the machine learning model to the IT environment after the training. The applying may include classifying, in real-time based on the one or more weights, the one or more potential security misconfigurations as one or more known misconfigurations, one or more suspicious misconfigurations, or one or more compliant configurations. The applying may include logging each of the one or more known misconfigurations at a known misconfiguration table. The applying may include reporting each of the one or more known misconfigurations to an administrator for remediation.

Aspects of the present disclosure provide a method detecting misconfigurations. The method may include training, via a training engine, a machine learning model to detect one or more potential security misconfigurations within an IT environment. The training may include inputting an input dataset, the input dataset including a set of known security configurations for the IT environment and known security misconfigurations for the IT environment. The training may include comparing the input dataset to an output dataset, the output dataset generated by the machine learning model. The training may include, based on the comparing, adjusting one or more weights of the machine learning model. The method may include applying, via an inference engine, the machine learning model to the IT environment after the training. The applying may include classifying, in real-time based on the one or more weights, the one or more potential security misconfigurations as one or more known misconfigurations, one or more suspicious misconfigurations, or one or more compliant configurations. The method may include logging, via a misconfiguration detection system, each of the one or more known misconfigurations at a known misconfiguration table. The method may include reporting, via the misconfiguration detection system, each of the one or more known misconfigurations to an administrator for remediation.

Other aspects of the present disclosure provide: one or more devices (e.g., apparatuses) operable, configured, or otherwise adapted to perform the aforementioned methods as well as those described elsewhere herein; a non-transitory, computer-readable media including computer-executable instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus including means for performing the aforementioned methods as well as those described elsewhere herein. By way of example, an apparatus may include a processing system, or processing systems cooperating over one or more message passing interfaces.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Embodiments of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the embodiments disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

FIG. 1 depicts an example of an enhanced detect architecture, in accordance with at least one aspect of the present disclosure.

FIG. 2 depicts an example of an enhanced detection workflow, in accordance with at least one aspect of the present disclosure.

FIG. 3 depicts an example method for enhanced detection , in accordance with at least one aspect of the present disclosure.

FIG. 4 depicts an example system for enhanced detection, in accordance with at least one aspect of the present disclosure.

FIG. 5 depicts an example computer system for enhanced detection, in accordance with at least one aspect of the present disclosure.

FIG. 6 depicts an example cloud computing system for enhanced detection, in accordance with at least one aspect of the present disclosure.

FIG. 7 depicts an example computer system for enhanced detection, in accordance with at least one aspect of the present disclosure.

### DETAILED DESCRIPTION

Aspects of the present disclosure will now be described in detail with reference to the accompanying drawing figures. Like elements in the various figures may be denoted by like reference numerals. Further, in the following detailed description, specific details are set forth in order to provide a more thorough understanding of the claimed subject matter. However, it will be apparent to one of ordinary skill in the art that the aspects disclosed herein may be practiced without these specific details, or with details that are not described herein in the interest of clarity. Thus, in some instances, well-known features have not been described in detail to avoid unnecessarily complicating the description. Additionally, it will be apparent to one of ordinary skill in the art that the scale of the elements presented in the accompanying drawing figures may vary without departing from the scope of the present disclosure.

Security misconfigurations represent a vulnerability in information systems, arising from improper or inadequate configuration of security settings. These misconfigurations can occur at various levels of an IT infrastructure, including network devices, operating systems, databases, and application frameworks. Common examples include default accounts with unchanged passwords, unnecessary services enabled, default configurations that are insecure, and incomplete configurations that leave systems exposed to potential threats. To mitigate the risks associated with security misconfigurations, systems and methods provided herein may implement robust configuration management practices.

Aspects in accordance with the present disclosure generally relate to detecting security misconfigurations by an enhanced detection architecture, and more particularly to methods and processes for automating the identification of security misconfigurations using system/application logs and machine learning. This includes analyzing log data to detect common misconfigurations such as the activation of insecure services (e.g., telecommunication network (TELNET), file transfer protocol (FTP), HyperText Transfer Protocol (HTTP), Simple Network Management Protocol Version 1 (SNMPV1)). The process involves comparing log entries against a database of known misconfigurations to identify potential security issues. If a match is found, the system alerts the concerned entities for remediation. If there is uncertainty, the system performs further analysis and updates the database accordingly. This method ensures that security misconfigurations, especially those not supported by existing configuration management technologies, are detected and reported promptly.

The enhanced detection architecture may include dynamic procedures for analyzing log data and identifying security misconfigurations. Procedures implemented on the enhanced detection architecture support flexible and adaptive detection mechanisms, ensuring that systems and applications are monitored for potential security issues based on their specific configurations and usage patterns. Additionally, the process includes adaptive configuration based on the analysis of log data, allowing for dynamic and context-sensitive detection of misconfigurations. Filtering capabilities are also included to simplify the job of system administrators, making it easier to manage and configure detection rules. Furthermore, the enhanced detection architecture may be able to test and validate the identified misconfigurations, providing a comprehensive view of potential security issues and ensuring that detections are accurate and actionable. This may facilitate efficient security administration and may address challenges associated with conventional ways of detecting security misconfigurations.

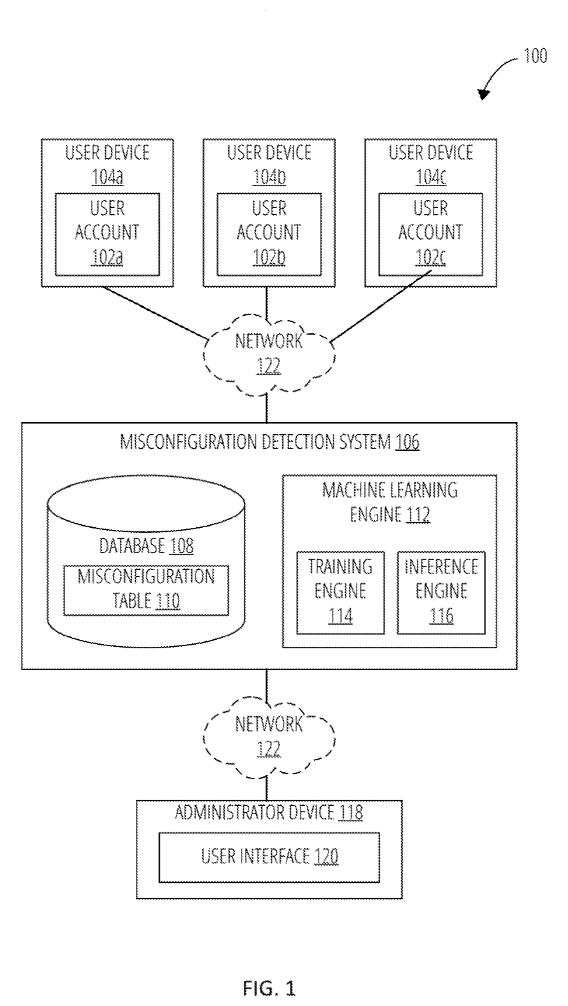

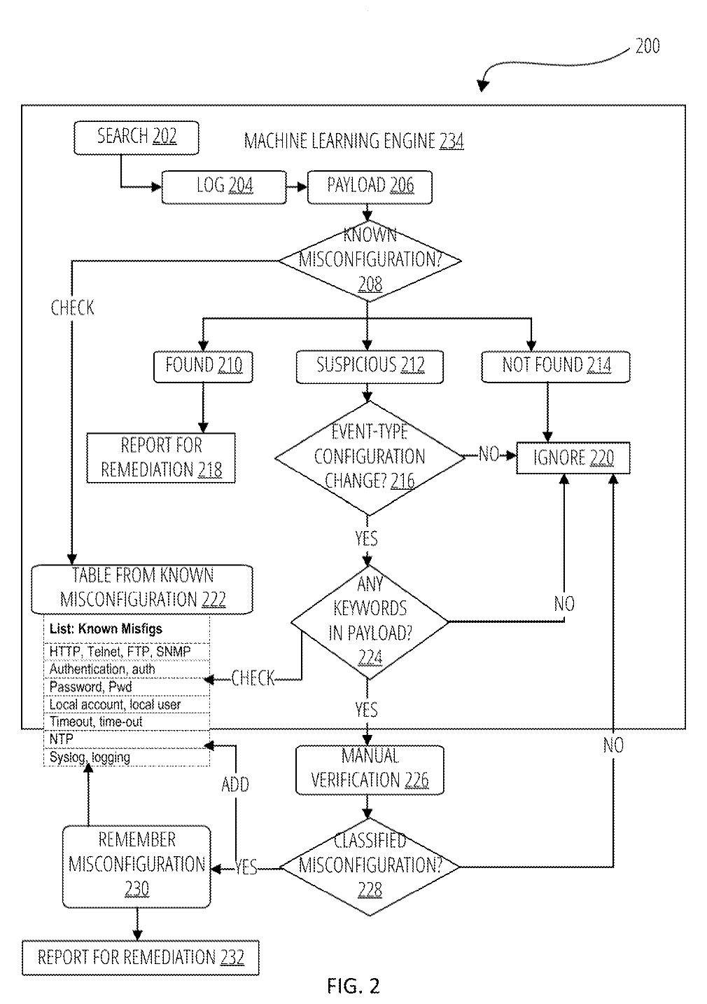

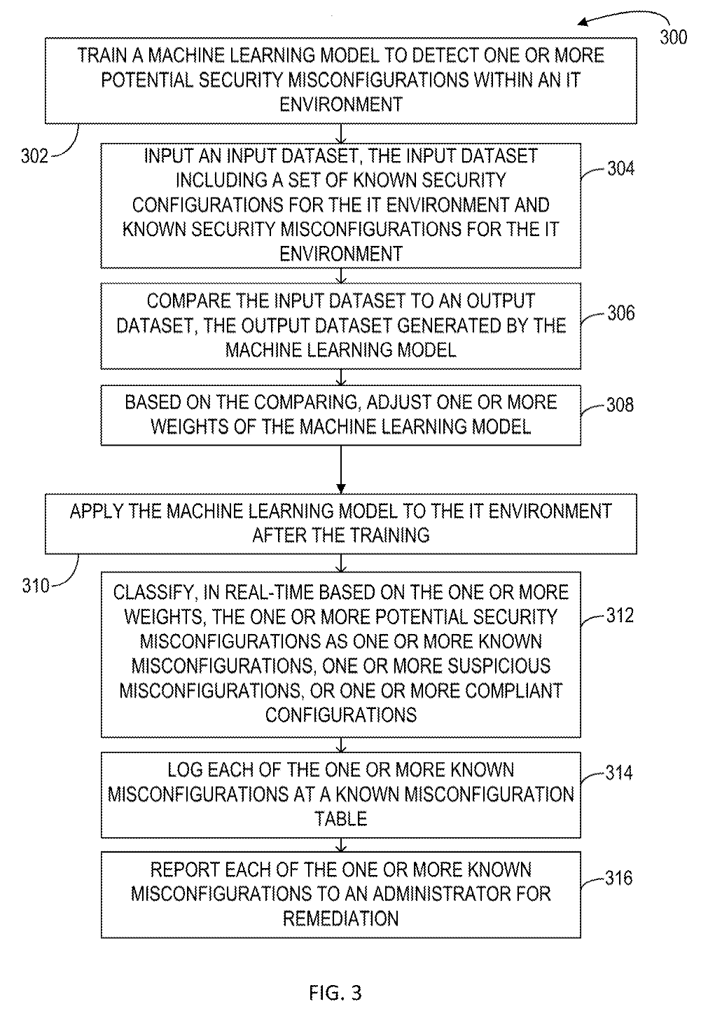

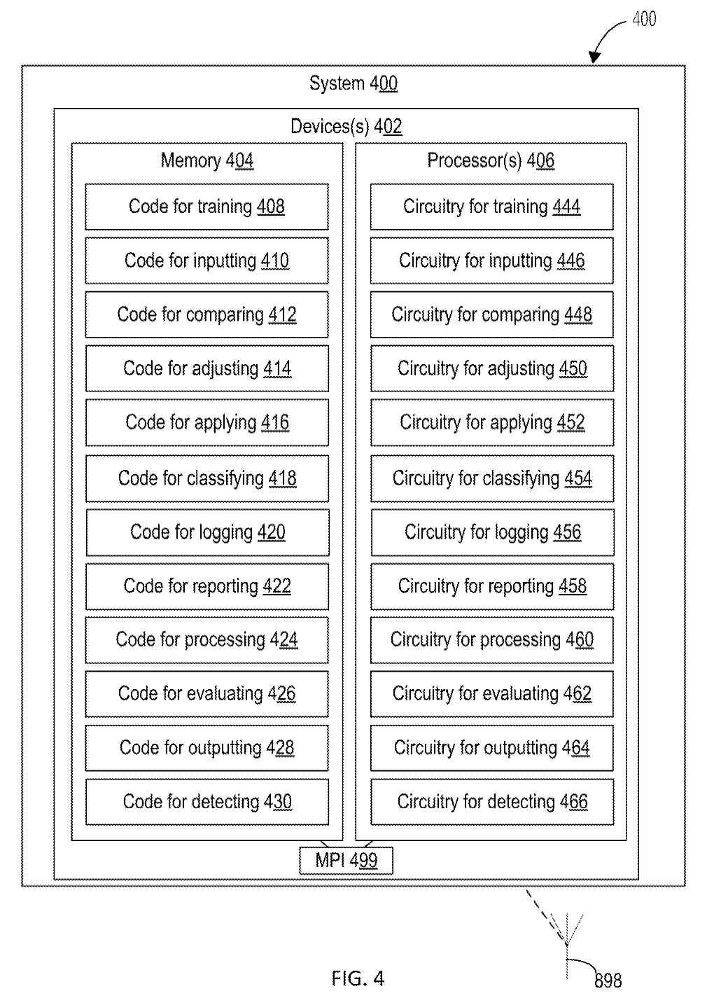

Aspects of the present disclosure provide an enhanced architecture for misconfiguration detection in an IT environment, such as enhanced detection architecture 100 illustrated in FIG. 1. Enhanced detection architecture 100 includes user account 102a, optional user account 102b, optional user account 102c, user device 104a, optional user device 104b, optional user device 104c, machine learning engine 112, database 108, misconfiguration table 110, training engine 114, inference engine 116, misconfiguration detection system 106, user interface 120, administrator device 118, and optional network 122. Enhanced detection architecture 100 may be configured or otherwise arranged to perform all or part of an enhanced misconfiguration detection procedure (e.g., misconfiguration detection procedure misconfiguration detection procedure 200 of FIG. 2, method 300 of FIG. 3, and the like). Enhanced detection architecture 100 may be considered one example of an applicable architecture for performing misconfiguration detection procedures described herein. Other suitable architectures, which may be similar to enhanced detection architecture 100, are also considered within the scope of this disclosure. In some cases, enhanced detection architecture 100 may be considered the same as or similar to system 400 of FIG. 4.

In at least one aspect, misconfiguration detection system 106 includes database 108, misconfiguration table 110, machine learning engine 112, training engine 114, and inference engine 116. In at least one example, database 108 stores misconfiguration table 110. In at least one example, machine learning engine 112 includes training engine 114 and inference engine 116.

In at least one aspect, each of user account 102a, optional user account 102b, optional user account 102c, user device 104a, optional user device 104b, optional user device 104c, machine learning engine 112, database 108, training engine 114, inference engine 116, misconfiguration detection system 106, and/or administrator device 118 may be practically implemented as one or more units, one or more databases, and/or one or more devices. In at least one aspect, each of user account 102a, optional user account 102b, optional user account 102c, user device 104a, optional user device 104b, optional user device 104c, machine learning engine 112, database 108, training engine 114, inference engine 116, misconfiguration detection system 106, and/or administrator device 118 may have at least one memory and one or more processors having computer readable instructions stored thereon, which are capable of implementing enhanced data processing schemes as part of enhanced detection architecture 100. In at least one aspect, each of user account 102a, optional user account 102b, optional user account 102c, user device 104a, optional user device 104b, optional user device 104c, machine learning engine 112, database 108, training engine 114, inference engine 116, misconfiguration detection system 106, and/or administrator device 118 may have at least one memory and one or more processors having computer readable instructions stored thereon, which are capable of implementing enhanced anomaly detection schemes as part of the function of enhanced detection architecture 100. The one or more processor(s) of each of user account 102a, optional user account 102b, optional user account 102c, user device 104a, optional user device 104b, optional user device 104c, machine learning engine 112, database 108, training engine 114, inference engine 116, misconfiguration detection system 106, and/or administrator device 118 may be central processing units (CPUs). The one or more processor(s) of each of user account 102a, optional user account 102b, optional user account 102c, user device 104a, optional user device 104b, optional user device 104c, machine learning engine 112, database 108, training engine 114, inference engine 116, misconfiguration detection system 106, and/or administrator device 118 may be graphics processing units (GPUs). Where there is more than one processor, each processor may operate independently from one another or as part of the same network of controllers and/or systems. Where multiple processors are part of the same network of controllers and/or systems, they may operate in sequence with one another, in parallel with one another, as physical components of a shared virtual machine, or as components of server-less network capable of processing decomposed flow data (e.g., a Kubernetes-based architecture). Where there is more than one processor, each processor may undergo decomposition to perform some or all of a performance of a method, such as method 300 of FIG. 3 described herein, in order to increase the efficiency of enhanced detection architecture 100.

In at least one aspect misconfiguration detection system 106 may perform methods provided herein, such as the method 300 of FIG. 3. To implement methods herein, misconfiguration detection system 106 may facilitate storage of misconfiguration table 110 at database 108. Further, misconfiguration detection system 106 may prompt machine learning engine 112, which may be electronically coupled to the database. Training engine 114 at machine learning engine 112 may be configured or otherwise arranged to train a machine learning model to detect one or more potential security misconfigurations within an IT environment. Training by training engine 114 may include inputting an input dataset, the input dataset including a set of known security configurations for the IT environment and known security misconfigurations for the IT environment. Training by training engine 114 may include comparing the input dataset to an output dataset, the output dataset generated by the machine learning model. Training by training engine 114 may include, based on the comparing, adjusting one or more weights of the machine learning model. Inference engine 116 at machine learning 112 may be configured or otherwise arranged to apply the machine learning model to the IT environment after the training. Applying by the inference engine 116 may include classifying, in real-time based on the one or more weights, the one or more potential security misconfigurations as one or more known misconfigurations, one or more suspicious misconfigurations, or one or more compliant configurations (e.g., “not found” misconfigurations). Applying by the inference engine 116 may include logging each of the one or more known misconfigurations at the known misconfiguration table. Applying by the inference engine 116 may include reporting each of the one or more known misconfigurations to an administrator and/or administrator device 118 for remediation.

In at least one aspect, each of user devices 102a-c may access misconfiguration detection system 106 of enhanced data processing architecture of FIG. 1. Access may be facilitated via network 122. User accounts 102a-b implemented on user devices 104a-c may allow a user to access an IT environment. Non-administrative (non-admin) users may affect an IT environment via user devices 104a-c in a variety of ways. By way of non-limiting example, a non-admin user using user account 102a on user device 104a may passively affect security configurations by connecting personal devices to network 122 of the IT environment, which can alter network traffic patterns. Additionally, certain passwords associated with user account 102a can influence the overall security configuration by affecting certain authentication protocols. A non-admin user might store information in various locations on user device 104a, potentially impacting data protection measures. They may also install software on user device 104a, which can interfere with existing security configurations of the IT environment and introduce compatibility considerations. Additional actions by a non-admin user which may affect configurations of the IT environment are considered within the scope of the disclosure. Each affected security configurations may be detected at misconfiguration detection system 106, which may detect and log each misconfiguration via database 108 and misconfiguration detection system 106 according to systems and methods described herein. Misconfiguration detection system 106 may support the import and export of various file formats relating to user accounts 102a-c, ensuring compatibility with industry standards. Misconfiguration detection system 106 may facilitate the application of different processing techniques and algorithms described herein to enhance the efficacy of misconfiguration detection procedures.

In at least one aspect, user devices 104a-c of the enhanced data enhanced detection architecture 100 of FIG. 1 includes a browser, which may utilize misconfiguration detection system 106 via user accounts 102a-c. In at least one aspect, misconfiguration detection system 106 may be accessed by each of user devices 104a-c via network 122. In at least one aspect, each of user devices 104a-c can be any electronic computing device. Each of user devices 104a-c may be a computing device that has a display. A non-admin user can enter control inputs through a user interface (such as a keyboard, microphone, or touchscreen). For example, each of user devices 104a-c can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (e.g., wired, or wireless) over network 122. In at least one aspect, each of user devices 104a-c may be a remote computing device that includes a tool having a user-interface configured to allow a user to access user accounts 102a-c.

In at least one aspect, database 108 may include one or more of relational databases (RDBMS) which use structured query language (SQL) for data management, NoSQL databases (e.g., document stores, key-value stores, column-family stores, graph databases), in-memory databases, NewSQL databases, time-series databases, object-oriented databases, hierarchical databases, network databases, distributed databases, cloud databases, multimodel databases, embedded databases, and the like. Database 108 may be treated as a data warehouse, data lake, data well, or another storage system. Database 108 may be optimized for misconfiguration detection, allowing the enhanced misconfiguration detection procedures described herein (e.g., procedure misconfiguration detection procedure 200, method 300, and the like).

In at least one example, database 108 may include misconfiguration table 110. Misconfiguration table 110 may include an array structure containing a variety of security misconfigurations. The array structure may be suitable for storage at database 108. Data at misconfiguration table 110 may include HTTP, TELNET, FTP, and SNMP configuration information. Data at misconfiguration table 110 may include authentication and authorization information. Data at misconfiguration table 110 may include password information for all users within the IT environment. Data at misconfiguration table 110 may include information regarding local accounts, local users, and the like. Data at misconfiguration table 110 may include timeout information. Data at misconfiguration table 110 may include network time protocol (NTP) information. Data at misconfiguration table 110 may include logging information, system logging information, and the like. In one example, misconfiguration table 110 can be manipulated via SQL commands, such as INSERT, UPDATE, DELETE, and SELECT, which allow misconfiguration detection system 106 to add, modify, remove, and retrieve data, respectively. Additionally, misconfiguration detection system 106 administrators can create and alter database schemas, including tables, indexes, and relationships, to optimize data organization and access. Stored procedures and triggers can be implemented to automate tasks and enforce business rules within the database. Furthermore, misconfiguration table 110 may be imported or exported using various tools and formats, such as CSV or JSON, to facilitate integration with other systems.

In one aspect machine learning engine 112 may facilitate enhanced misconfiguration detection at misconfiguration detection system 106. Machine learning engine 112 may be configured or otherwise arranged to search for, log, and load security misconfigurations for a given IT environment. Machine learning engine 112 can be configured to search for, log, and load security misconfigurations in a given IT environment through a series of systematic and technical steps. Initially, machine learning engine 112 can train a training engine 114 using a comprehensive dataset that includes various examples of security configurations and misconfigurations. This dataset should encompass a wide range of scenarios, including network settings, user permissions, software configurations, and compliance standards. Training at the training engine 114 may include using supervised learning procedures where training engine 114 learns to distinguish between correct and incorrect configurations based on labeled data. To achieve this capability, training may include inputting the correct and incorrect configurations, comparing the correct and incorrect configurations to results from a machine learning model subject to training at training engine 114, and adjusting weights of the machine learning model based on the comparing.

To effectively identify security misconfigurations, a well-trained machine learning model trained at training engine 114 can employ specialized detection techniques at inference engine 116 that focus on vulnerabilities arising from incorrect settings or configurations in security systems. By applying the machine learning model at inference engine 116, misconfiguration detection system 106 may identify insecure services that are enabled, default credentials that have not been changed, and other configuration errors that increase the risk of exploitation. By continuously monitoring the IT environment, machine learning engine 112 can compare real-time configuration data against the learned baseline of secure configurations. Any deviations from this baseline that match known misconfiguration patterns can be flagged as potential vulnerabilities.

To log the identified misconfigurations, machine learning engine 112 may be integrated with a logging system (e.g., at misconfiguration detection system 106, further described with respect to machine learning engine 234 of FIG. 2). The logging system supplied at misconfiguration detection system 106 can store detailed records of each detected misconfiguration, including the time of detection, the specific configuration parameters involved, and the potential impact on the IT environment. The logging mechanism can also include metadata such as the source of the configuration data and any relevant contextual information. This structured logging approach ensures that all detected issues are documented comprehensively, facilitating further analysis and remediation. In at least one example, detected misconfigurations may be stored as known information. Known information may be utilized by machine learning engine 112 to reduce redundant operations that would detect duplicate misconfigurations. After logging, misconfiguration detection system 106 may load the security detected misconfigurations from machine learning engine 112 to presenting the logged data in a format that is actionable for IT administrators. Loading may include outputting information regarding the detected security misconfigurations to administrator device 118. Machine learning engine 112 and/or misconfiguration detection system 106 can generate reports or dashboards that summarize the detected misconfigurations, highlighting critical issues that require immediate attention, and output such items to administrator device 118, for example via network 122. These reports can be customized to include visualizations, such as charts and graphs, to provide a clear overview of the security posture. Additionally, machine learning engine 112 may be configured or otherwise arranged to offer recommendations for resolving the misconfigurations, leveraging its learned knowledge to suggest best practices and corrective actions.

To enhance its effectiveness, machine learning engine 112 can be configured to continuously update its knowledge base with new data. This involves periodically retraining the model with fresh examples of security configurations and incorporating feedback from IT administrators on the accuracy of the detected misconfigurations. By maintaining an up-to-date understanding of the evolving security landscape, the engine can adapt to new threats and configuration standards, ensuring that it remains a valuable tool for maintaining the security of the IT environment.

As used herein, the term “machine learning model” can refer to a computer model used to facilitate one or more machine learning tasks (e.g., regression and/or classification tasks). For example, a machine learning model can represent relationships (e.g., causal or correlation relationships) between parameters and/or outcomes within the context of a specified domain. For instance, machine learning models can represent the relationships via probabilistic determinations that can be adjusted, updated, and/or redefined based on historic data and/or previous executions of a machine learning task. In various aspects described herein, machine learning models can simulate a number of interconnected processing units that can resemble abstract versions of neurons. For example, the processing units can be arranged in a plurality of layers (e.g., one or more input layers, hidden layers, and/or output layers) connected by varying connection strengths (e.g., which can be commonly referred to within the art as “weights”).

Machine learning models can learn through training with one or more training datasets; where data with known outcomes input into the machine learning model, outputs regarding the data are compared to the known outcomes, and/or the weights of the machine learning model are autonomously adjusted based on the comparison to replicate the known outcomes. As the one or more machine learning models train (e.g., utilize more training data), the machine learning models can become increasingly accurate; thus, trained machine learning models can accurately analyze data with unknown outcomes, based on lessons learned from training data and/or previous executions, to facilitate one or more machine learning tasks.

Example types of machine learning models can include, but are not limited to: artificial neural network (“ANN”) models, perceptron (“P”) models, feed forward (“FF”) models, radial basis network (“RBF”) models, deep feed forward (“DFF”) models, recurrent neural network (“RNN”) models, long/short memory (“LSTM”) models, gated recurrent unit (“GRU”) models, auto encoder (“AE”) models, variational AE (“VAE”) models, denoising AE (“DAE”) models, sparse AE (“SAE”) models, markov chain (“MC”) models, Hopfield network (“HN”) models, Boltzmann machine (“BM”) models, deep belief network (“DBN”) models, convolutional neural network (“CNN”) models, deep convolutional network (“DCN”) models, deconvolutional network (“DN”) models, deep convolutional inverse graphics network (“DCIGN”) models, generative adversarial network (“GAN”) models, liquid state machine (“LSM”) models, extreme learning machine (“ELM”) models, echo state network (“ESN”) models, deep residual network (“DRN”) models, kohonen network (“KN”) models, support vector machine (“SVM”) models, and/or neural turing machine (“NTM”) models.

In at least one aspect, each of administrator device 118 may access misconfiguration detection system 106 of enhanced data processing architecture of FIG. 1. Further, administrator device 118 may receive items and/or transmissions from misconfiguration detection system 106, as described above. Administrator device 118 may also be configured or otherwise arranged to send commands to misconfiguration detection system 106 to configure misconfiguration detection system 106 and address detected misconfigurations in an appropriate manner. Access and communication may be facilitated via network 122. Administrator device 118 may support user interface 120, which may allow an administrative user (admin-user) to access and/or modify an IT environment. Admin users may affect an IT environment via user devices 104a-c in a variety of ways. By way of example, admin users may update system settings via user interface 120 at administrator device 118 to disable insecure services and change default credentials to strong, unique passwords. Administrators can also apply, via user interface 120 at administrator device 118, security patches and updates to software and firmware to address known vulnerabilities. Additionally, administrators can, via user interface 120 at administrator device 118, implement and enforce security policies, such as access controls and encryption standards, to ensure compliance with best practices and regulatory requirements. Administrators can also, via user interface 120 at administrator device 118, review and adjust user permissions to ensure that only authorized personnel have access to sensitive data and critical systems. Additional actions by a non-admin user which may cure configurations of the IT environment in response to feedback from misconfiguration detection system 106 are considered within the scope of the disclosure. Each detected security configurations may be delivered in some form to administrator device 118, which may allow an administrator to cure misconfiguration according to systems and methods described herein.

In at least one aspect, administrator device 118 of the enhanced data enhanced detection architecture 100 of FIG. 1 includes a browser, which may utilize misconfiguration detection system 106 via user interface 120. In at least one aspect, misconfiguration detection system 106 may be accessed by administrator device 118 via network 122. In at least one aspect, administrator device 118 can be any electronic computing device. Administrator device 118 may be a computing device that has a display. An admin user can enter control inputs through a user interface (such as a keyboard, microphone, or touchscreen). For example, administrator device 118 can include, but is not limited to, a mobile computing device (such as a smartphone or tablet computer), wearable computing device (such as a smart watch or headset), a desktop computer, laptop computer, set-top box, smart television, smart display screen, kiosk, or other type of computing device having at least one processor and computer-readable memory. In addition to at least one processor and memory, such a computing device may include software, firmware, hardware, or a combination thereof. Software may include one or more applications, a browser, and an operating system. Hardware can include, but is not limited to, a processor, memory, display or other input/output device. A communication interface and transceiver can be included to perform data communication (e.g., wired, or wireless) over network 122. In at least one aspect, administrator device 118 may be a remote computing device that includes a tool having a user-interface configured to allow a user to access misconfiguration detection system 106.

In at least one aspect, network 122 may be practically implemented as one or more networks. Network 122 may be a wired network, a wireless network, or a combination of both. In at least one aspect, a wireless network may include a wireless local area network (WLANs) (e.g., a wireless fidelity (Wi-Fi) network), a wireless personal area networks (WPANs) (e.g., a Bluetooth network, a Zigbee network), a wireless metropolitan area network (WMANs) (e.g., a worldwide interoperability for microwave access (WiMAX) network), a wireless wide area network (WWANs) (e.g., a fourth generation long-term evolution (4G LTE) network, a fifth generation new radio (5G NR) network, satellite networks, mesh networks, ad hoc networks, near field communication (NFC) networks, infrared (IR) communication networks, ultra-wideband (UWB) networks, long range wide area networks (LoRaWAN) (e.g., a network optimized for Internet-of-Things (IoT) applicability), and the like.

Various embodiments described herein can constitute one or more technical improvements over conventional misconfiguration detection operations by incorporating advanced classification techniques using certain supervised machine learning techniques. Additionally, one or more embodiments described herein can have a practical application by training machine learning models to perform the security misconfiguration detection in real-time for the whole of an IT system, removing duplicative manual operations and increasing evaluation throughput by many orders of magnitude using automated workflows applied to each potential security misconfiguration. For example, one or more embodiments described herein can enhance the accuracy and throughput of security misconfiguration, specifically with respect to system-critical configurations, by capturing the whole of an IT system in real-time and applying a trained machine learning model to each detection as soon as the detection occurs. Moreover, the machine learning engine can be trained to validate detected misconfigurations against known misconfigurations in real-time, which may then allow the engine to train on additional detection information, increasing the reliability of systems and methods provided herein.

Aspects of the present disclosure may be further understood with respect to misconfiguration detection procedure 200 of FIG. 2. Misconfiguration detection procedure 200 may be implemented by machine learning engine 234. In some cases, machine learning engine 234 may be understood to be similar or the same as machine learning engine 112. Where some or all of misconfiguration detection procedure 200 is not implemented at a machine learning such as machine learning engine 112 or machine learning engine 234, some or all of misconfiguration detection procedure 200 may be implemented by some or all of an architecture (e.g., enhanced detection architecture 100) and/or some or all of a system (e.g., misconfiguration detection system 106).

In the illustrated, non-limiting example of FIG. 2, misconfiguration detection procedure 200 begins when machine learning engine 234 performs a search step 202 to detect security misconfigurations within a log management system. In some cases, search step 202 may be implemented by an inference engine (e.g., inference engine 116) applying a well-trained machine learning model (e.g., trained by training engine 114, as described with respect to FIG. 1). Once security misconfigurations are discovered via search step 202, machine learning engine 234 performs a log step 204. Log step 204 may be implemented by an inference engine (e.g., inference engine 116) applying a well-trained machine learning model (e.g., trained by training engine 114, as described with respect to FIG. 1). In some cases, log step 204 is performed by analyzing text associated with the discovered misconfiguration. Logged misconfigurations may be combined by machine learning engine 234 in a payload step 206.

Misconfigurations are then evaluated at step 208 to determine whether each misconfiguration is known. To determine whether a misconfiguration is known, machine learning engine 234 and/or an associated system may check a table of known misconfigurations (e.g., misconfiguration table 110 of FIG. 1). Based on the check, the quality of the misconfigurations, or both the check and the quality of the misconfiguration, machine learning engine 234 and/or an associated system may proceed according to a “found” procedure 210, a “suspicious” procedure 212, or a “not found” procedure. The found procedure 210 prompts machine learning engine 234 and/or an associated system to generate and deliver a report for remediation 218. In some cases, report for remediation 218 may be delivered to an administrator device 118, or may be logged in a system for automated remediation. The not found procedure 214 prompts machine learning engine 234 and/or an associated system to ignore the misconfiguration at endpoint 220, ending misconfiguration detection procedure 200 with respect to that specific detected misconfiguration.

The suspicious procedure 212 prompts machine learning engine 234 and/or an associated system to evaluate at step 216 whether the detected misconfiguration is an event-type configuration change. In one example an event-type configuration change that may be considered a security misconfiguration refers to any alteration in the settings or parameters of a system, application, or network that inadvertently introduces vulnerabilities or weakens the security posture. These changes can occur during routine maintenance, updates, or modifications and may include enabling insecure services, using default or weak credentials, improperly configuring access controls, or failing to apply necessary security patches. Such misconfigurations can be exploited by malicious actors to gain unauthorized access, disrupt services, or compromise data integrity and confidentiality. If, at step 216, the detected security misconfiguration is not an event-type configuration change, machine learning engine 234 and/or an associated system ignores the misconfiguration at endpoint 220, ending misconfiguration detection procedure 200 with respect to that specific detected misconfiguration.

If, at step 216, the detected security misconfiguration is an event-type configuration change, machine learning engine 234 and/or an associated system may proceed to step 224, where machine learning engine 234 and/or an associated system evaluates whether the detected security misconfiguration contains any keywords. In one example, a security misconfiguration may contain keywords when specified terms or phrases are present within the configuration settings that indicate potential vulnerabilities or issues. These keywords can be used by machine learning engine 234 and/or an associated system to identify and flag more serious misconfigurations at step 224. Examples of such keywords might include “default,” “admin,” “password,” “open,” “unrestricted,” “insecure,” “test,” or “public.” The presence of these keywords can signal that certain security best practices have not been followed, such as using default credentials, leaving ports open, or not properly restricting access. For instance, if a configuration file contains the keyword "default" in the context of user credentials (e.g., "username: admin, password: default"), it suggests that the default password has not been changed, which is a common security misconfiguration. Similarly, the keyword "open" in firewall settings might indicate that a port is left open to all traffic, potentially exposing the system to unauthorized access.

To evaluate whether there are keywords in a payload, machine learning engine 234 and/or an associated system may check table from known misconfiguration 222 for significant similarities between known misconfigurations and the misconfiguration subject to evaluation. If, at step 224, the detected security misconfiguration is not deemed to contain a keyword, machine learning engine 234 and/or an associated system ignores the misconfiguration at endpoint 220, ending misconfiguration detection procedure 200 with respect to that specific detected misconfiguration.

If, either based on the check or based on other suitable considerations, the machine learning engine 234 and/or an associated system detects a keyword present in the security misconfiguration, the security misconfiguration is forwarded to an administrator for manual verification at step 226. In at least one example, step 226 may be performed after the targeted security misconfiguration is forwarded to an administrator device (e.g., administrator device 118), where manual verification may then be performed at a user interface (e.g., user interface 120) of the administrator device. During manual verification, the targeted security misconfiguration may be finally classified at step 228. If, at step 228, the targeted security misconfiguration is not finally classified as a security misconfiguration, machine learning engine 234 and/or an associated system ignores the targeted misconfiguration at endpoint 220, ending misconfiguration detection procedure 200 with respect to that specific detected misconfiguration. If, at step 228, the targeted security misconfiguration is finally classified as a security misconfiguration, the targeted security misconfiguration is added to table from known misconfiguration 222 at remember misconfiguration step 230. Steps 228 and 230 may be performed automatically by systems and/or architectures provided herein to catalog known misconfigurations efficiently and effectively (e.g., as they occur in real time, or batched to facilitate computational and energy efficiency). Machine learning engine 234 and/or an associated system may then forward the new known misconfiguration to an administrator for remediation at step 232, in a manner comparable to step 218.

The current technology described herein offers significant advantages by leveraging machine learning and a log management system to detect security misconfigurations. This technology initiates a search for security misconfigurations within the log management system and analyzes the discovered text to determine whether the misconfiguration is known. If recognized, an alert is sent to the system owner for remediation. If uncertain, the machine conducts further analysis by checking if the event type is a configuration-change and searches the database for keyword matches, forwarding the information for manual verification if a match is found. This process ensures that the database is updated and the issue is reported for remediation. Unlike general anomaly detection, which focuses on identifying patterns or behaviors that deviate from the norm and may include both malicious actions and benign changes, this technology specifically targets security misconfigurations. It addresses vulnerabilities arising from incorrect settings or configurations, such as insecure services or default credentials. This targeted approach enhances the accuracy and efficiency of identifying and remediating security misconfigurations, thereby providing a more robust and specialized solution for maintaining system security.

### Example Methods

FIG. 3 is a schematic flowchart of an example method 300 for implementing enhanced misconfiguration detection by one or more processors, such as the processors of system 400 of FIG. 4.

Method 300 begins at operation 302 with one or more processors of a training engine training a machine learning model to detect one or more potential security misconfigurations within an IT environment.

Operation 302 may include operation 304, with one or more processors of a training engine inputting an input dataset, the input dataset including a set of known security configurations for the IT environment and known security misconfigurations for the IT environment.

Operation 302 may include operation 306, with one or more processors of a training engine comparing the input dataset to an output dataset, the output dataset generated by the machine learning model.

Operation 302 may include operation 308, with one or more processors of a training engine, based on the comparing, adjusting one or more weights of the machine learning model.

Method 300 may continue with operation 310, with one or more processors of an inference engine applying the machine learning model to the IT environment after the training. In at least one example, applying the machine learning model after the training further includes: detecting, in real-time, the one or more potential security misconfigurations within the IT environment. In at least one example, detecting, in real-time, the one or more potential security misconfigurations within the IT environment further includes: detecting, in real-time, the one or more potential security misconfigurations at one or more user devices connected to the misconfiguration detection system via a network; detecting, in real-time, the one or more potential security misconfigurations at the misconfiguration detection system; and detecting, in real-time, the one or more potential security misconfigurations at one or more administrator devices connected to the misconfiguration detection system via the network.

Operation 310 may include operation 312, with one or more processors of an inference engine classifying, in real-time based on the one or more weights, the one or more potential security misconfigurations as one or more known misconfigurations, one or more suspicious misconfigurations, or one or more compliant configurations.

Operation 310 may include operation 314, with one or more processors of an inference engine logging each of the one or more known misconfigurations at a known misconfiguration table. In at least one example, the known misconfiguration table includes insecure service misconfigurations. In at least one example, the known misconfiguration table is stored at a database. In at least one example, the insecure service misconfigurations include at least one of: telecommunication network misconfigurations; FTP misconfigurations; HTTP misconfigurations; and SNMPV1 misconfigurations. In at least one example, the known misconfiguration table includes: authentication misconfigurations; password misconfigurations; and local account misconfigurations. In at least one example, the known misconfiguration table includes at least one of: time-out misconfigurations; network time protocol (NTP) misconfigurations; and logging misconfigurations.

Operation 310 may include operation 316, with one or more processors of an inference engine reporting each of the one or more known misconfigurations to an administrator for remediation.

Method 300 may optionally continue with one or more processors of an inference engine processing the one or more suspicious misconfigurations to further classify each of the one or more suspicious misconfigurations as either: one of the one or more known misconfigurations; or one of the one or more compliant configurations. In at least one example, processing the one or more suspicious misconfigurations includes: evaluating whether each of the one or more suspicious misconfigurations are event configuration changes. In at least one example, processing the one or more suspicious misconfigurations further includes: based on the evaluating, classifying a portion of the one or more suspicious misconfigurations that are not one of the event configuration changes as one of the one or more compliant configurations. In at least one example, processing the one or more suspicious misconfigurations further includes: based on the evaluating, further evaluating a portion of the one or more suspicious misconfigurations that are one of the event configuration changes for presence of at least one keyword. In at least one example, processing the one or more suspicious misconfigurations further includes: based on the further evaluating, classifying a sub-portion of the one or more suspicious misconfigurations without the at least one keyword as one of the one or more compliant configurations. In at least one example, processing the one or more suspicious misconfigurations further includes: based on the evaluating, classifying a sub-portion of the one or more suspicious misconfigurations with the at least one keyword as one of the one or more known misconfigurations. In at least one example, the sub-portion is output to an administrator device for manual verification.

In one aspect, method 300, or any aspect related to it, may be performed by a system, device, apparatus, or architecture, such as the architecture 100 of FIG. 1 or system 400 of FIG. 4, which includes various components operable, configured to, or adapted to perform the method 300. System 400 is described below in further detail.

FIG. 3 is just one example of a method, and other methods including fewer, additional, or alternative operations are contemplated consistent with the disclosure.

To address the pervasive threat of hackers and cybercriminals targeting companies for monetizable data, organizations can implement systems and methods provided herein to enhance their IT security. Proactive measures described herein may form the foundation of a robust defensive and protective plan, helping to prevent data breaches and business disasters. The enhanced configuration management tools provided herein may be useful to detect security misconfigurations, ensuring the consistency and accuracy of security settings, and safeguarding computer systems, networks, and applications. Such tools help identify and rectify improperly implemented or default security settings that could otherwise leave systems vulnerable to attacks and compromise sensitive data and resources.

Moreover, systems and methods provided herein may cure gaps inherent to security tools in the current state of the art, which may not cover all systems and applications, particularly web-based ones and those that do not support data transfer protocols for parsing configurations. Aspects of the present disclosure address these gaps by utilizing system and application logs coupled with machine learning to detect or automate the detection of security misconfigurations. By checking for misconfigurations in the log management system, such as indications in the payload that depict activation or utilization of insecure services or configurations, efficient and reliable security protocol may be achieved.

### Example Systems

FIG. 4 illustrates a schematic diagram of an example system 400. The system 400 may be implemented as part of the enhanced security misconfiguration detection described with respect to FIGS. 1-3. Components of the system may be implemented at a single location or at multiple locations and may be a supervisory system or may be in communication with a supervisory system by way of a communication line. In at least one embodiment, the communication line may be a wireless communication line, a wired communication line, or both, though other types of communication line are contemplated.

The device(s) 402 may include a CPU processing system, which may be configured to perform anomaly detection procedures, such as those described herein with respect to FIG. 1-3, as performed by the system 400. The CPU processing system of the device(s) 402 may include one or more processors 406 coupled to a computer readable medium/memory 404, for example via a bus (not shown). The one or more processors 406 and the computer readable medium/memory 404 may communicate via a message passing interface (MPI) 499. In certain aspects the computer readable medium/ memory 404 is configured to store instructions (e.g., computer executable code) that when executed by the one or more processors 406, cause the one or more processors to perform the method 300 described with respect to FIG. 3, or any aspect related to it. Reference to a single processor performing a function of system 400 may include one or more processors performing that function of system 400.

In the depicted example, computer-readable medium/memory 404 stores code (e.g., executable instructions) 408 for training, code 410 for inputting, code 412 for comparing, code 414 for adjusting, code 416 for applying, code 418 for classifying, code 420 for logging, code 422 for reporting, code 424 for processing, code 426 for evaluating, code 428 for outputting, and code 430 for detecting. Processing of code 408-430 may cause the system 400 to perform the method 300 described with respect to FIG. 3, or any aspect related to it.

The one or more processors 406 include circuitry configured to implement (e.g., execute) the code stored in the computer-readable medium / memory 404, including circuitry 444 for training, circuitry 446 for inputting, circuitry 448 for comparing, circuitry 450 for adjusting, circuitry 452 for applying, circuitry 454 for classifying, circuitry 456 for logging, circuitry 458 for reporting, circuitry 460 for processing, circuitry 462 for evaluating, circuitry 464 for outputting, and circuitry 466 for detecting. Processing with circuitry 444-466 may cause the system 400 to perform the method 300 described with respect to FIG. 3, or any aspect related to it.

Various components of the system 400 may provide means for performing the method 300 described with respect to FIG. 3, or any aspect related to it.

The system 400 may include or be substantially coupled to a communication component 498. In the depicted example, the communication component 498 is an antenna capable of communicating with controllers similar to system 400 to perform the method 300 described with respect to FIG. 3, or any aspect related to it. In additional examples, the communication component 498 may be a bus or a wired connection.

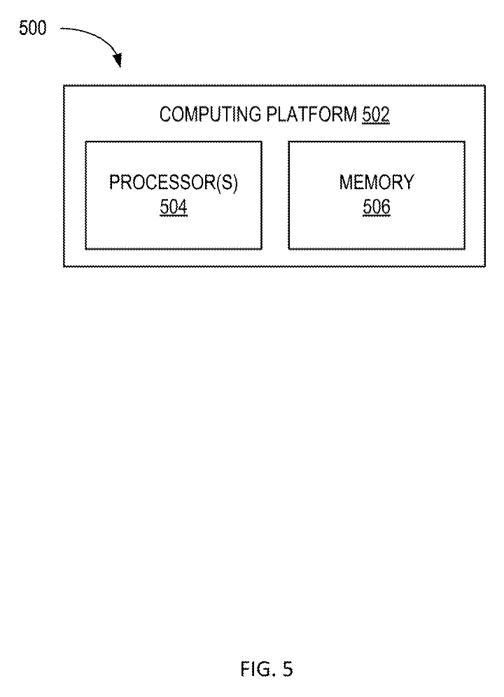

FIG. 5 is an example of a block diagram of a system 500. System 500 can be implemented using one or more modules, shown in block form in the drawings. The one or more modules can be in software, firmware or hardware form, or a combination thereof. In some examples, system 500 can be implemented as machine readable instructions for execution on one or more computing platforms 502 (referred to as a computing platform herein), as shown in FIG. 5. The computing platform 502 can include one or more computing devices selected from, for example, a desktop computer, a server, a controller, a blade, a mobile phone, a tablet, a laptop, a personal digital assistant (PDA), and the like.

The computing platform 504 can include a processor 504 and a memory 506. By way of example, the memory 506 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 504 can be implemented, for example, as one or more processor cores. The memory 506 can store machine-readable instructions that can be retrieved and executed by the processor 504 to implement system 500. Each of the processor 504 and the memory 506 can be implemented on a similar or a different computing platform. The computing platform 502 can be implemented in a cloud computing environment (for example, as disclosed herein) and thus on a cloud infrastructure. In such a situation, features of the computing platform 502 can be representative of a single instance of hardware or multiple instances of hardware executing across the multiple of instances (e.g., distributed) of hardware (e.g., computers, routers, memory, processors, or a combination thereof). Alternatively, the computing platform 502 can be implemented on a single dedicated server or workstation.

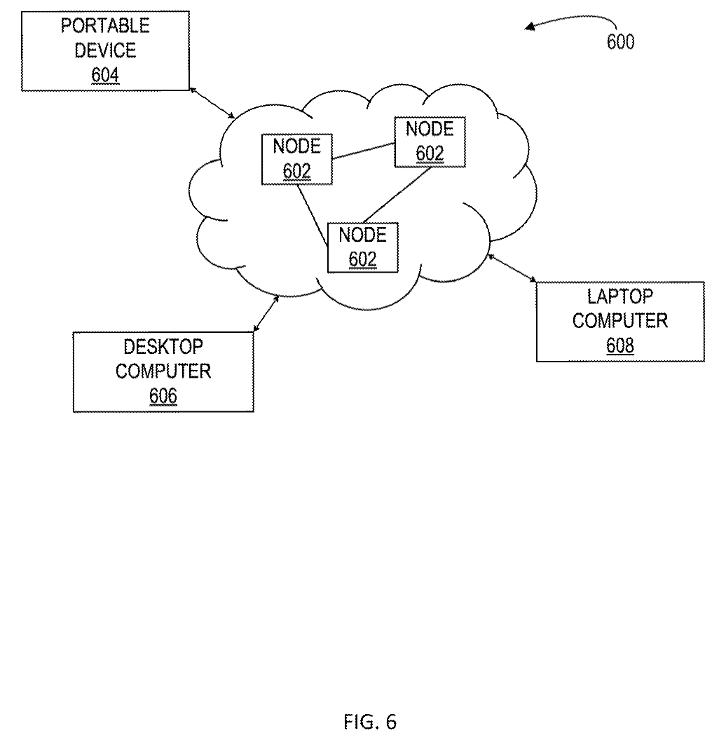

FIG. 6 is an example of a cloud computing environment 600 that can be used for implementing one or more modules and/or systems in accordance with one or more examples, as disclosed herein. Thus, reference can be made to one or more examples of FIGS. 1-7 in the example of FIG. 6. As shown, cloud computing environment 600 can include one or more cloud computing nodes 602 with which local computing devices used by cloud consumers (or users), such as, for example, personal digital assistant (PDA), cellular, or portable device 604, a desktop computer 606, and/or a laptop computer 608, may communicate. The computing nodes 602 can communicate with one another. In some examples, the computing nodes 602 can be grouped (not shown) physically or virtually, in one or more networks, such as Private, Community, Public, or Hybrid clouds, or a combination thereof. This allows the cloud computing environment 600 to offer infrastructure, platforms and/or software as services for which a cloud consumer does not need to maintain resources on a local computing device. The devices 604-608, as shown in FIG. 6, are intended to be illustrative and that computing nodes 602 and cloud computing environment 600 can communicate with any type of computerized device over any type of network and/or network addressable connection (e.g., using a web browser). In some examples, the one or more computing nodes 602 are used for implementing one or more examples disclosed herein relating to root-source identification. Thus, in some examples, the one or more computing nodes can be used to implement modules, platforms, and/or systems, as disclosed herein.

In some examples, the cloud computing environment 600 can provide one or more functional abstraction layers. It is to be understood that the cloud computing environment 600 need not provide all of the one or more functional abstraction layers (and corresponding functions and/or components), as disclosed herein. For example, the cloud computing environment 600 can provide a hardware and software layer that can include hardware and software components. Examples of hardware components include: mainframes; RISC (Reduced Instruction Set Computer) architecture based servers; servers; blade servers; storage devices; and networks and networking components. In some embodiments, software components include network application server software and database software.

In some examples, the cloud computing environment 600 can provide a virtualization layer that provides an abstraction layer from which the following examples of virtual entities may be provided: virtual servers; virtual storage; virtual networks, including virtual private networks; virtual applications and operating systems; and virtual clients. In some examples, the cloud computing environment 600 can provide a management layer that can provide the functions described below. For example, the management layer can provide resource provisioning that can provide dynamic procurement of computing resources and other resources that are utilized to perform tasks within the cloud computing environment. The management layer can also provide metering and pricing to provide cost tracking as resources are utilized within the cloud computing environment 600, and billing or invoicing for consumption of these resources. In one example, these resources may include application software licenses. Security provides identity verification for cloud consumers and tasks, as well as protection for data and other resources. The management layer can also provide a user portal that provides access to the cloud computing environment 600 for consumers and system administrators. The management layer can also provide service level management, which can provide cloud computing resource allocation and management such that required service levels are met. Service Level Agreement (SLA) planning and fulfillment can also be provided to provide pre-arrangement for, and procurement of, cloud computing resources for which a future requirement is anticipated in accordance with an SLA.

In some examples, the cloud computing environment 600 can provide a workloads layer that provides examples of functionality for which the cloud computing environment 600 may be utilized. Examples of workloads and functions which may be provided from this layer include: mapping and navigation; software development and lifecycle management; virtual classroom education delivery; data analytics processing; and transaction processing. Various embodiments of the present disclosure can utilize the cloud computing environment 600.

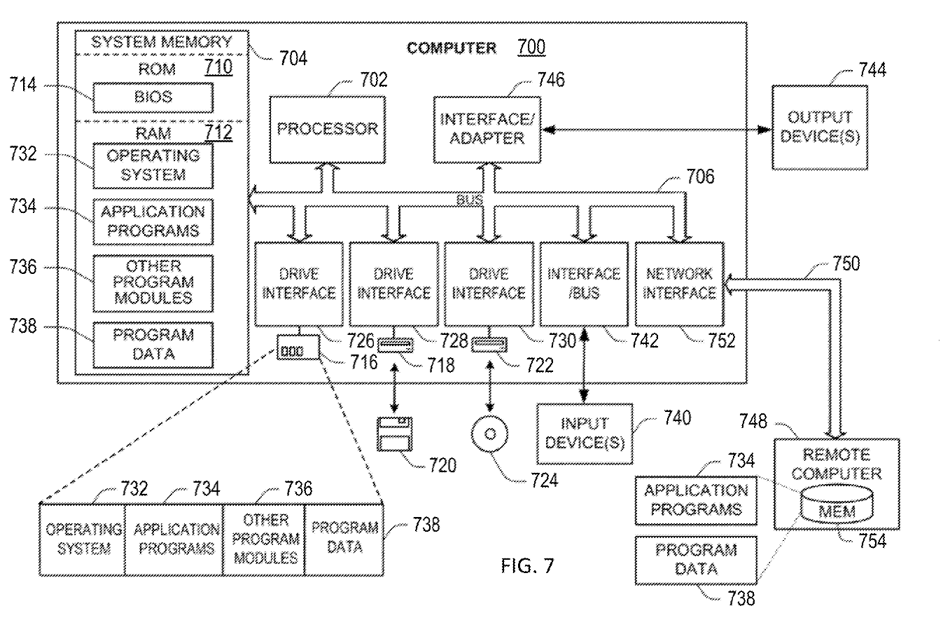

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 7. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 7 illustrates one example of a computer system 700 that can be employed to execute one or more embodiments of the present disclosure. Computer system 700 can be implemented on one or more general purpose networked computer systems, embedded computer systems, routers, switches, server devices, client devices, various intermediate devices/nodes or standalone computer systems. Additionally, computer system 700 can be implemented on various mobile clients such as, for example, a personal digital assistant (PDA), laptop computer, pager, and the like, provided it includes sufficient processing capabilities.

Computer system 700 includes processing unit 702, system memory 704, and system bus 706 that couples various system components, including the system memory 704, to processing unit 702. System memory 704 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 702. System bus 706 may be any of several types of bus structure including a memory bus or memory controller, a peripheral bus, and a local bus using any of a variety of bus architectures. System memory 704 includes read only memory (ROM) 710 and random access memory (RAM) 712. A basic input/output system (BIOS) 714 can reside in ROM 710 containing the basic routines that help to transfer information among elements within computer system 700.

Computer system 700 can include a hard disk drive 716, magnetic disk drive 718, e.g., to read from or write to removable disk 720, and an optical disk drive 722, e.g., for reading CD-ROM disk 724 or to read from or write to other optical media. Hard disk drive 716, magnetic disk drive 718, and optical disk drive 722 are connected to system bus 706 by a hard disk drive interface 726, a magnetic disk drive interface 728, and an optical drive interface 730, respectively. The drives and associated computer-readable media provide nonvolatile storage of data, data structures, and computer-executable instructions for computer system 700. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

Computer system 700 may operate in a networked environment using logical connections to one or more remote computers, such as remote computer 748. Remote computer 748 may be a workstation, computer system, router, peer device, or other common network node, and typically includes many or all the elements described relative to computer system 700. The logical connections, schematically indicated at 750, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 700 can be connected to the local network through a network interface or adapter 752. When used in a WAN networking environment, computer system 700 can include a modem, or can be connected to a communications server on the LAN. The modem, which may be internal or external, can be connected to system bus 706 via an appropriate port interface. In a networked environment, application programs 734 or program data 738 depicted relative to computer system 700, or portions thereof, may be stored in a remote memory storage device 754.

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

### Example Aspects

Implementation examples are described in the following numbered clauses.

Aspect 1: A misconfiguration detection system, including: a database, the database storing a known misconfiguration table; and a machine learning engine coupled to the database, the machine learning engine including: a training engine configured to train a machine learning model to detect one or more potential security misconfigurations within an information technology (IT) environment, the training including: inputting an input dataset, the input dataset including a set of known security configurations for the IT environment and known security misconfigurations for the IT environment; comparing the input dataset to an output dataset, the output dataset generated by the machine learning model; and based on the comparing, adjusting one or more weights of the machine learning model; and an inference engine configured to apply the machine learning model to the IT environment after the training, the applying including: classifying, in real-time based on the one or more weights, the one or more potential security misconfigurations as one or more known misconfigurations, one or more suspicious misconfigurations, or one or more compliant configurations; logging each of the one or more known misconfigurations at the known misconfiguration table; and reporting each of the one or more known misconfigurations to an administrator for remediation.

Aspect 2: The misconfiguration detection system of aspect 1, wherein applying the machine learning model after the training further includes: processing the one or more suspicious misconfigurations to further classify each of the one or more suspicious misconfigurations as either: one of the one or more known misconfigurations; or one of the one or more compliant configurations.

Aspect 3: The misconfiguration detection system of aspect 2, wherein processing the one or more suspicious misconfigurations includes: evaluating whether each of the one or more suspicious misconfigurations are event configuration changes.

Aspect 4: The misconfiguration detection system of aspect 3, wherein processing the one or more suspicious misconfigurations further includes: based on the evaluating, classifying a portion of the one or more suspicious misconfigurations that are not one of the event configuration changes as one of the one or more compliant configurations.

Aspect 5: The misconfiguration detection system of any one of aspects 3 through 4, wherein processing the one or more suspicious misconfigurations further includes: based on the evaluating, further evaluating a portion of the one or more suspicious misconfigurations that are one of the event configuration changes for presence of at least one keyword.

Aspect 6: The misconfiguration detection system of aspect 5, wherein processing the one or more suspicious misconfigurations further includes: based on the further evaluating, classifying a sub-portion of the one or more suspicious misconfigurations without the at least one keyword as one of the one or more compliant configurations.

Aspect 7: The misconfiguration detection system of any one of aspects 5 through 6, wherein processing the one or more suspicious misconfigurations further includes: based on the evaluating, classifying a sub-portion of the one or more suspicious misconfigurations with the at least one keyword as one of the one or more known misconfigurations.

Aspect 8: The misconfiguration detection system of aspect 7, wherein the sub-portion is output to an administrator device for manual verification.

Aspect 9: The misconfiguration detection system of any one of aspects 1 through 8, wherein applying the machine learning model after the training further includes: detecting, in real-time, the one or more potential security misconfigurations within the IT environment.

Aspect 10: The misconfiguration detection system of any one of aspects 1 through 9, wherein detecting, in real-time, the one or more potential security misconfigurations within the IT environment further includes: detecting, in real-time, the one or more potential security misconfigurations at one or more user devices connected to the misconfiguration detection system via a network; detecting, in real-time, the one or more potential security misconfigurations at the misconfiguration detection system; and detecting, in real-time, the one or more potential security misconfigurations at one or more administrator devices connected to the misconfiguration detection system via the network.

Aspect 11: The misconfiguration detection system of any one of aspects 1 through 10, wherein the known misconfiguration table includes insecure service misconfigurations.

Aspect 12: The misconfiguration detection system of aspect 11, wherein the insecure service misconfigurations include at least one of: telecommunication network misconfigurations; file transfer protocol (FTP) misconfigurations; hypertext transfer protocol (HTTP) misconfigurations; and simple network management protocol version 1 (SNMPV1) misconfigurations.

Aspect 13: The misconfiguration detection system of any one of aspects 1 through 12, wherein the known misconfiguration table includes: authentication misconfigurations; password misconfigurations; and local account misconfigurations.

Aspect 14: The misconfiguration detection system of any one of aspects 1 through 13, wherein the known misconfiguration table includes at least one of: time-out misconfigurations; network time protocol (NTP) misconfigurations; and logging misconfigurations.

Aspect 15: A method detecting misconfigurations, including: training, via a training engine, a machine learning model to detect one or more potential security misconfigurations within an IT environment, the training including: inputting an input dataset, the input dataset including a set of known security configurations for the IT environment and known security misconfigurations for the IT environment; comparing the input dataset to an output dataset, the output dataset generated by the machine learning model; and based on the comparing, adjusting one or more weights of the machine learning model; and applying, via an inference engine, the machine learning model to the IT environment after the training, the applying including: classifying, in real-time based on the one or more weights, the one or more potential security misconfigurations as one or more known misconfigurations, one or more suspicious misconfigurations, or one or more compliant configurations; logging each of the one or more known misconfigurations at a known misconfiguration table; and reporting each of the one or more known misconfigurations to an administrator for remediation.

Aspect 16: The method detecting misconfigurations of aspect 15, further including: processing the one or more suspicious misconfigurations to further classify each of the one or more suspicious misconfigurations as either: one of the one or more known misconfigurations; or one of the one or more compliant configurations.

Aspect 17: The method detecting misconfigurations of aspect 16, wherein processing the one or more suspicious misconfigurations includes: evaluating whether each of the one or more suspicious misconfigurations are event configuration changes.

Aspect 18: The method detecting misconfigurations of aspect 17, wherein processing the one or more suspicious misconfigurations further includes: based on the evaluating, further evaluating a portion of the one or more suspicious misconfigurations that are one of the event configuration changes for presence of at least one keyword.

Aspect 19: The method detecting misconfigurations of aspect 18, wherein processing the one or more suspicious misconfigurations further includes: based on the evaluating, classifying a sub-portion of the one or more suspicious misconfigurations with the at least one keyword as one of the one or more known misconfigurations.

Aspect 20: The method detecting misconfigurations of aspect 19, further including: outputting the sub-portion to an administrator device for manual verification.

Aspect 21: A method detecting misconfigurations. The method may include training, via a training engine, a machine learning model to detect one or more potential security misconfigurations within an IT environment. The training may include inputting an input dataset, the input dataset including a set of known security configurations for the IT environment and known security misconfigurations for the IT environment. The training may include comparing the input dataset to an output dataset, the output dataset generated by the machine learning model. The training may include, based on the comparing, adjusting one or more weights of the machine learning model. The method may include applying, via an inference engine, the machine learning model to the IT environment after the training. The applying may include classifying, in real-time based on the one or more weights, the one or more potential security misconfigurations as one or more known misconfigurations, one or more suspicious misconfigurations, or one or more compliant configurations. The applying may include logging each of the one or more known misconfigurations at a known misconfiguration table. The applying may include reporting each of the one or more known misconfigurations to an administrator for remediation.

Aspect 22: An apparatus or device including a memory comprising executable instructions, and a processor configured to execute the executable instructions and cause the apparatus to perform a method in accordance with any one of aspects 1-21.

Aspect 23: An apparatus or device, including means for performing a method in accordance with any one of aspects 1-21.

Aspect 24: A non-transitory computer-readable medium including executable instructions that, when executed by a processor of an apparatus, cause the apparatus to perform a method in accordance with any one of aspects 1-21.

Aspect 25: A computer program product embodied on a computer-readable storage medium comprising code for performing a method in accordance with any one of aspects 1-21.

### Additional Considerations

Although this disclosure includes a detailed description on a computing platform and/or computer, implementation of the teachings recited herein are not limited to only such computing platforms. Rather, embodiments of the present disclosure are capable of being implemented in conjunction with any other type of computing environment now known or later developed.

Systems and methods provided herein may be implemented using serverless architecture, such as a “Kubernetes” architecture. Kubernetes is an open-source container orchestration platform that may manage containerized applications across a cluster of nodes. Within its architecture, several data types are integral to its operation and management. These data types include “Pods,” which are the smallest and simplest Kubernetes objects that represent a single instance of a running process in a cluster. “Nodes,” another critical data type, are the worker machines in Kubernetes, which can be either virtual or physical. Deployments are used to manage a set of identical Pods, ensuring that the desired number of Pods are running at any given time. Services, which define a logical set of Pods and a policy by which to access them, are essential for enabling network access to the Pods. “ConfigMaps” and “Secrets” are used to manage configuration data and sensitive information, respectively. “PersistentVolumes” and “PersistentVolumeClaims” handle storage resources, allowing Pods to request and use storage dynamically. Namespaces provide a mechanism to partition resources within a single Kubernetes cluster, facilitating multi-tenancy and resource management.

In Kubernetes architectures, various types of databases can be deployed to manage and store data efficiently. Relational databases, such as “MySQL” and “PostgreSQL,” are commonly used for structured data and support atomicity, consistency, isolation, and durability (ACID) transactions, making them suitable for applications requiring complex queries and data integrity. “NoSQL” databases, including “MongoDB” and “Cassandra,” are designed for unstructured data and offer high scalability and flexibility, which is ideal for applications with large volumes of data and varying data models. Key-Value stores like “Redis” and “etcd” are optimized for fast read and write operations, often used for caching and configuration management. Time-series databases, such as “InfluxDB” and “Prometheus,” are specialized for handling time-stamped data, making them perfect for monitoring and analytics applications. Additionally, “NewSQL” databases, like “CockroachDB,” combine the scalability of NoSQL systems with the ACID guarantees of traditional relational databases, providing a balanced solution for modern applications. These diverse database types enable Kubernetes to support a wide range of application requirements, from transactional systems to real-time analytics and beyond.

The present disclosure may be a system, a method, and/or a computer program product at any possible technical detail level of integration. The computer program product may include a computer readable storage medium (or media) having computer readable program instructions thereon for causing a processor to conduct aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or conduct combinations of special purpose hardware and computer instructions.

“Real-time” may refer to the capability of a system or process to respond to inputs or events within a strict period of time, such as immediately or within seconds or milliseconds. In computing and information technology, real-time systems may be designed to process data and provide outputs instantaneously or almost instantaneously, ensuring minimal latency.

“Continuous” may refer to operating without interruption, constantly monitoring and responding in real-time to changes, ensuring a seamless flow of operations. Examples include real-time video surveillance and live data streaming.

“Semi-continuous”, also known as quasi-continuous or intermittent, may refer to activity occurring in regular intervals or cycles, pausing briefly between periods of activity. This allows for periodic updates while maintaining consistent performance. Examples include batch processing and scheduled data synchronization.

“Event-based”, or event-driven, may refer to activity occurring in response to specific occurrences or triggers (e.g., rather than functioning continuously). An event-based system remains idle until an event of interest occurs, then processes the event and performs necessary tasks. Examples include security alarms and user interface interactions.

The terminology used herein is for the purpose of describing particular embodiments only and is not intended to limit the disclosure. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection and is not limited to either unless expressly referenced as such. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The term “based on” means “based at least in part on.” The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 5-10% of the indicated number.

While the disclosure has described several exemplary embodiments, it will be understood by those skilled in the art that various changes can be made, and equivalents can be substituted for elements thereof, without departing from the spirit and scope of the disclosure. In addition, many modifications will be appreciated by those skilled in the art to adapt a particular instrument, situation, or material to embodiments of the disclosure without departing from the essential scope thereof. Therefore, it is intended that the disclosure not be limited to the particular embodiments disclosed, or to the best mode contemplated for conducting this disclosure, but that the disclosure will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A misconfiguration detection system, comprising:
a database configured to store a known misconfiguration table; and
a machine learning engine coupled to the database, the machine learning engine including:
a training engine configured to train a machine learning model to detect one or more potential security misconfigurations within an information technology (IT) environment, wherein the training engine is configured to::
input an input dataset, the input dataset including a set of known security configurations for the IT environment and known security misconfigurations for the IT environment;
compare the input dataset to an output dataset, the output dataset generated by the machine learning model; and
based on the comparing, adjust one or more weights of the machine learning model; and
an inference engine configured to apply the machine learning model to the IT environment after the training, wherein the inference engine is configured to:
classify, in real-time based on the one or more weights, the one or more potential security misconfigurations as one or more known misconfigurations, one or more suspicious misconfigurations, or one or more compliant configurations;
log each of the one or more known misconfigurations at the known misconfiguration table; and
report each of the one or more known misconfigurations to an administrator for remediation.

2. The misconfiguration detection system of claim 1, wherein the inference engine is further configured to apply the machine learning model after training includes configuration to
process the one or more suspicious misconfigurations to further classify each of the one or more suspicious misconfigurations as either:
one of the one or more known misconfigurations; or
one of the one or more compliant configurations.

3. The misconfiguration detection system of claim 2, wherein the inference engine is further configured to evaluate whether each of the one or more suspicious misconfigurations are event configuration changes.

4. The misconfiguration detection system of claim 3, wherein the inference engine is further configured to classify a portion of the one or more suspicious misconfigurations that are not one of the event configuration changes as one of the one or more compliant configurations.

5. The misconfiguration detection system of claim 3, wherein the inference engine is further configured to evaluate a portion of the one or more suspicious misconfigurations that are one of the event configuration changes for presence of at least one keyword.

6. The misconfiguration detection system of claim 5, wherein the inference engine is further configured to classify a sub-portion of the one or more suspicious misconfigurations without the at least one keyword as one of the one or more compliant configurations.

7. The misconfiguration detection system of claim 5, wherein the inference engine is further configured to classify a sub-portion of the one or more suspicious misconfigurations with the at least one keyword as one of the one or more known misconfigurations.

8. The misconfiguration detection system of claim 7, wherein the sub-portion is output to an administrator device for manual verification.

9. The misconfiguration detection system of claim 1, wherein the inference engine is further configured to
detect, in real-time, the one or more potential security misconfigurations within the IT environment.

10. The misconfiguration detection system of claim 1, wherein the inference engine is further configured to:
detect, in real-time, the one or more potential security misconfigurations at one or more user devices connected to the misconfiguration detection system via a network;
detect, in real-time, the one or more potential security misconfigurations at the misconfiguration detection system; and
detect, in real-time, the one or more potential security misconfigurations at one or more administrator devices connected to the misconfiguration detection system via the network.

11. The misconfiguration detection system of claim 1, wherein the known misconfiguration table includes insecure service misconfigurations.

12. The misconfiguration detection system of claim 11, wherein the insecure service misconfigurations include at least one of:
telecommunication network misconfigurations;
file transfer protocol (FTP) misconfigurations;
hypertext transfer protocol (HTTP) misconfigurations; and
simple network management protocol version 1 (SNMPV1) misconfigurations.

13. The misconfiguration detection system of claim 1, wherein the known misconfiguration table includes:
authentication misconfigurations;
password misconfigurations; and
local account misconfigurations.

14. The misconfiguration detection system of claim 1, wherein the known misconfiguration table includes at least one of:
time-out misconfigurations;
network time protocol (NTP) misconfigurations; and
logging misconfigurations.

15. A method of detecting misconfigurations, comprising:
training, via a training engine, a machine learning model to detect one or more potential security misconfigurations within an information technology (IT) environment, the training including:
inputting an input dataset, the input dataset including a set of known security configurations for the IT environment and known security misconfigurations for the IT environment;
comparing the input dataset to an output dataset, the output dataset generated by the machine learning model; and
based on the comparing, adjusting one or more weights of the machine learning model; and
applying, via an inference engine, the machine learning model to the IT environment after the training, the applying including:
classifying, in real-time based on the one or more weights, the one or more potential security misconfigurations as one or more known misconfigurations, one or more suspicious misconfigurations, or one or more compliant configurations;
logging each of the one or more known misconfigurations at a known misconfiguration table; and
reporting each of the one or more known misconfigurations to an administrator for remediation.

16. The method detecting misconfigurations of claim 15, further comprising:
processing the one or more suspicious misconfigurations to further classify each of the one or more suspicious misconfigurations as either:
one of the one or more known misconfigurations; or
one of the one or more compliant configurations.

17. The method detecting misconfigurations of claim 16, wherein processing the one or more suspicious misconfigurations comprises:
evaluating whether each of the one or more suspicious misconfigurations are event configuration changes.

18. The method detecting misconfigurations of claim 17, wherein processing the one or more suspicious misconfigurations further comprises:
based on the evaluating, evaluating a portion of the one or more suspicious misconfigurations that are one of the event configuration changes for presence of at least one keyword.

19. The method detecting misconfigurations of claim 18, wherein processing the one or more suspicious misconfigurations further comprises:
based on the evaluating, classifying a sub-portion of the one or more suspicious misconfigurations with the at least one keyword as one of the one or more known misconfigurations.

20. A method of detecting misconfigurations, comprising:
training, via a training engine, a machine learning model to detect one or more potential security misconfigurations within an information technology (IT) environment, the training including:
inputting an input dataset, the input dataset including a set of known security configurations for the IT environment and known security misconfigurations for the IT environment;
comparing the input dataset to an output dataset, the output dataset generated by the machine learning model; and
based on the comparing, adjusting one or more weights of the machine learning model; and
applying, via an inference engine, the machine learning model to the IT environment after the training, the applying including classifying, in real-time based on the one or more weights, the one or more potential security misconfigurations as one or more known misconfigurations, one or more suspicious misconfigurations, or one or more compliant configurations;
logging, via a misconfiguration detection system electronically coupled to the inference engine, each of the one or more known misconfigurations at a known misconfiguration table; and
reporting, via the misconfiguration detection system electronically coupled to the inference engine, each of the one or more known misconfigurations to an administrator for remediation.
